(19) United States
(12) Patent Application Publication
(10) Pub. No.: US 2002/0162000 A1
(43) Pub. Date: Oct. 31, 2002

(54) Method for the verification of the integrity and authorship of a text

(76) Inventor: Hartwig Benzler, Feidkirchen-Westerham (DE)

Correspondence Address: KLAUS J. BACH & ASSOCIATES, PATENTS AND TRADEMARKS, 4407 TWIN OAKS LANE, MURRYSVILLE, PA, 15668, US

(21) Appl. No.: 09/948,794

(22) Filed: Sep. 10, 2001

Related U.S. Application Data
(63) Continuation-in-part of application No. PCT/EP00/03512, filed on Apr. 18, 2000.

(30) Foreign Application Priority Data
May 22, 1999 (DE) 199 23 590.2
May 31, 1999 (DE) 199 24 726.9
Jun. 28, 1999 (DE) 199 29 601.4
Sep. 3, 1999 (DE) 199 42 082.3
Sep. 16, 1999 (DE) 199 44 595.8
Sep. 25, 1999 (DE) 199 46 004.3
Mar. 7, 2000 (DE) 100 10 365.0

(51) Int. Cl. H04L 9/30

(52) U.S. Cl. 713/170; 380/30; 713/172

(57) ABSTRACT

In a method concerning the verification of the integrity and authorship of a text is revealed based on the use of a tripartite electronic signature:

$$\begin{matrix}K = 72085 \; 33172 \\ S = 04381 \; 80478 \\ U = 42866 \; 39105\end{matrix}$$

the tripartite electronic signature is consists of a token (K), identifying the author of the text, a hash value of the text called its “text seal” (S) that is calculated from the characters of the text and their disposition with a public one-way algorithm, and the so called “signature proof” (U) calculated from S with a private one-way algorithm, dependent on a secret code G. The tripartite electronic signature replaces a hand written personal signature. For verification, the tripartite electronic signature is sent to an autonomous module, where its three numbers are analysed. As the result, the verifying person receives the message: signature is valid or not valid.

In order to be able to perform this analysis, the module contains a data bank which stores the secret codes G of all the participants marked with their token K. Entering a specific token K of a participant in the data bank releases his/her secret code G for the recalculation of the signature proof U from the text seal S with the private one-way algorithm. The newly calculated U is compared with its counterpart in the tripartite electronic signature as entered in the module. This enables the module to release the above mentioned message.

A trustworthy instance supervises that only such value pairs (secret code G and token K) can be entered in the data bank, whose owners have proved their identity and the relevance of their token K to that identity. By means of a symmetric cipher dependent on the secret code G, attributed to all participants and to the module, texts can be encoded by their author, sent to the module, decoded and re-encoded in the module, sent to the addressee, and decoded by the latter.

### BACKGROUND OF THE INVENTION

1. Field of the Invention

The invention relates to a method for the verification of the integrity and authorship of a text. The purpose of the invention is to provide an easily implementable method for generating and verifying an electronic signature of a text, which is to be transmitted conventionally or electronically, or which merely is to be permanently archived. A further purpose of the invention is to combine this method with the possibility to encode and decode texts with a private symmetric cipher, which is under the sole control of its owner.

2. State of the art

Contrary to the hand written signature of a document, a digital or electronic signature as known since about 25 years which is used as its replacement for electronically transmitted communications, cannot be easily perceived and is not permanently placed on paper. It is electronically checked directly after the receipt of the communication.

$$\begin{matrix}\begin{matrix} iQA / AwUBONp 0 g 4 Od + PaAQUT 1 EQIc 5 AcdGkKSzp \\ OrsT 0 Gvj 3 jH 9 NXD 8 ZP 2 IcAn 0 vj / BHT + qQCtPCtCwO\end{matrix} \\ 1 aQ 3 Xk / NL = 1 CZt\end{matrix}$$

An electronic signature needs permanent access to the relevant trust center, in order to check whether the public key is still valid. Experience shows that Internet services may be deliberately blocked. Such loss of access to the trust center would temporarily rescind the legally effective use of the electronic signature.

As concerns the encoding and decoding of texts, methods are known where the sender encodes his/her communications with his/her own security key, where inside a secure central station or a secure module these communications are decoded with a duplicate of this security key and re-encoded with a duplicate of the addressee's security key, and where the addressee decodes the communications with his/her own security key. One of these methods (WO 98/00947) provides for a storage of duplicates of the security keys of all the participants are stored in a data bank of the central station, each together with an index key designating the participant to whom it belongs. The duplicate security keys of the sender and addressee of a communication are activated by entering the sender's and addressee's index keys in the data bank. One drawback of this method is that an aggressor may intercept the communication of the sender, in order to replace the index key of the addressee in the plain main header of the communication by his/her own key, and to pass on the thus forged communication to the central station, from where he/she receives a cipher text which he/she decodes with his/her own security key. A second draw back of this method is that no security provisions are foreseen which prevent the input of forged index keys into the data bank.

The following patent applications or other documents are describing further details of the present state of the art:

PCT/EP00/0 (WO 00/72502 A1): Description of a method for verifying the integrity and authorship of and encoding and decoding texts with an electronic signature which is calculated from a text by a one-way algorithm and a code number, and which is reconstructed for verification in a secure module accessible by telecommunication. The module is also used for decoding and re-encoding of cipher texts transferred between a sender and an addressee.

M. BURROWS, M. ABADI and R. M. NEEDHAM: A Logic of Authentication. Rep. 39. Digital Equipment Corporation Systems Research Center, Palo Alto, Calif., Feb. 1989: Description of the conventional electronic signature based on the asymmetric cipher.

Simon GARFINKEL: PGP-Pretty Good Privacy. O'Reilly & Associates Inc., Cambridge 1995, pp. 46-48: Introduction to public key cryptography in general and its application to encrypt and sign documents with the program written by Phil Zimmermann in particular.

H. BENZLER: Authentisierverfahren mit Assoziationen. Datenschutz und Datensicherheit 12/96, pp. 723-728: Article about a new authentication method which avoids the use of PINs and codes, based on the principle that a person authenticates himself/herself by the reconstitution of personal associations, each consisting of two elements.

### SUMMARY OF THE INVENTION

The two purposes of the invention, i.e. first to provide an easily implementable method for generating and verifying an electronic signature of a text which is to be transmitted conventionally or electronically, or which merely is to be permanently archived, and secondly to combine this method with the possibility to encode and decode texts with a private symmetric cipher which is under the sole control of its owner, is achieved by the methods according to the invention. These methods are in particular based on the use of a tripartite electronic signature (I)

$$\begin{matrix}K = 72085 \; 33172 \\ S = 04381 \; 80478 \\ U = 42866 \; 39105\end{matrix}$$

which is constituted from a token (K), identifying the author of the text, a hash value of the text called its “text seal” (S) that is calculated from the characters of the text and their disposition with a public one-way algorithm, and the so called “signature proof” (U) calculated from S with a private one-way algorithm, dependent on a secret code G. The tripartite electronic signature (I) replaces a hand written personal signature.

For verification, the tripartite electronic signature I is sent to an autonomous module supervised by a trustworthy authority, where its three numbers are analyzed. As the result, the verifying person receives the message: signature is valid or not valid. By means of a symmetric cipher dependent on the secret code G, attributed to all participants and to the module, texts can be encoded by their author(s), sent to the module, decoded and re-encoded in the module, sent to the addressee, and decoded by the latter.

### BRIEF DESCRIPTION OF THE DRAWINGS

FIG. 1 illustrates the generation and verification of the tripartite electronic signature;

FIG. 2 shows how a cipher text is decoded and re-encoded in the module;

FIG. 3 shows how the data bank used in the embodiments is separated from the rest of the module;

FIG. 4 illustrates an exemplary original set of characters used for the symmetric cipher;

FIG. 5 illustrates an exemplary individual “alphabet” used for the symmetric cipher;

FIG. 6 shows a typical grid content before encoding with the symmetric cipher;

FIG. 7 illustrates a typical grid content after encoding with the symmetric cipher;

FIG. 8. shows an exemplary form for e-mail transfer of the embodiments;

FIG. 9 illustrates a typical e-commerce form of an embodiment.

### DETAILED DESCRIPTION OF THE INVENTION

The first object of the invention is to provide the text, in lieu of the hand written signature or as a complement to it, with a note deducted from the text and the author's identity which is, contrary to the electronic signature, short enough to be placed on paper without waste of space and to be recognized without efforts. The second object of the invention is to verify the authenticity of a text inside an autonomous module, by means of this note. The third object of the invention is to assign a supplementary function to that module by use of a simple complement, i.e. to symmetrically encode and decode texts which are communicated between two participants, without the possibility for the text to be diverted by an aggressor.

Apart from a note containing two numbers, a note according to the invention consists in particular of three numbers, the so called tripartite electronic signature I.

$$\begin{matrix}K = 72085 \; 33172 \\ S = 04381 \; 80478 \\ U = 42866 \; 39105\end{matrix}$$

The first number K of the tripartite electronic signature I is a token characterizing the signer of the text which may be deduced for instance from his/her name. The second number, the seal S, guarantees the integrity of the text. S is calculated from all the characters of the text and their disposition, by means of a one-way algorithm, which is generally accessible. The third number U is called signature proof and identifies the signer. U is calculated from the seal S by means, which are under the exclusive control of the signer, thus, in the simplest case, by a one-way algorithm, which is activated by a secret code of the signer.

Everyone getting sight of the text has the opportunity to check its integrity and authenticity in the following way: First, S is recalculated and compared with the corresponding value of the tripartite electronic signature I. Next, the signature is transmitted by telephone, by fax or via the Internet, to an autonomous module which is set up apart and generally accessible, and in which the three interrelated numbers of the signature are analyzed. As the result of this examination, which cannot be perceived nor influenced from the outside, the module transmits a message to the sender of the inquiry, either “signature valid” or “signature invalid”. For safety, separately accessible duplicates of the module may be arranged, in case of a breakdown of the module.

The method according to the invention solves the principal task of visually verifying the authenticity of an electronically transmitted text, not only on receipt, but also later on at any time. To that extent, the tripartite electronic signature I perfectly replaces the function of a personal signature permanently written on paper.

The tripartite electronic signature I complies with the requirements of an “advanced electronic signature” according to article 2 of the Directive 1999/93/EC of the European Parliament and of the Council of Dec. 13, 1999 on a Community framework for electronic signatures, and therefore automatically possesses the legal effectiveness of a hand written signature, if the qualifying framework conditions are fulfilled.

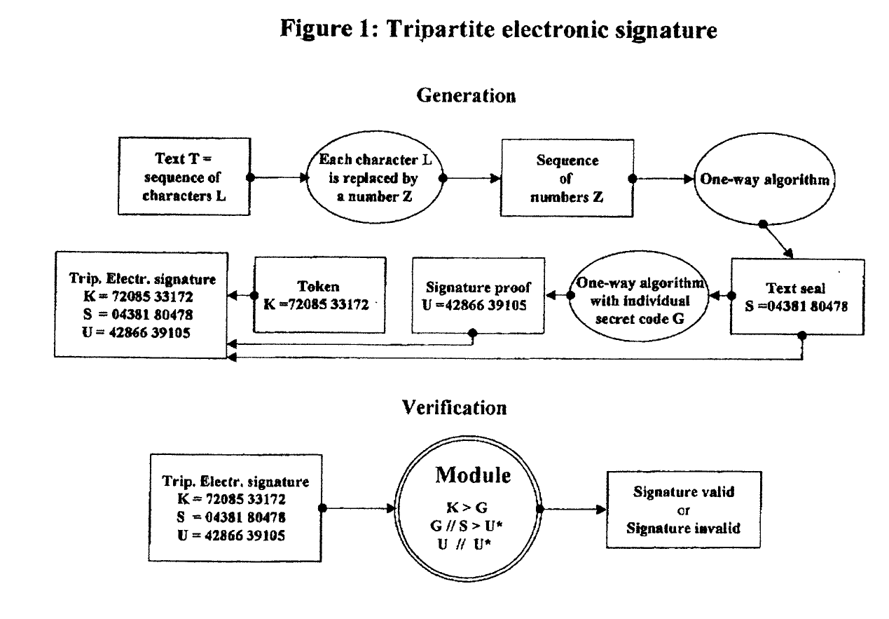

The principle of the generation and verification of the tripartite electronic signature I is represented in FIG. 1. In order to generate it, the seal S is calculated from the text and its disposition by means of a generally accessible one-way algorithm; the signature proof U is then calculated from S by means of a one-way algorithm defined by an individual secret code G of the signer. For safety, G is stored in a chip card or a diskette as a cipher value, and made available for use after an authentication of the owner.

In order to verify the tripartite electronic signature I, the seal S is recalculated from all the characters of the text and their disposition and compared with the S value of the signature. Thereafter, I is entered in an autonomous module which is accessible via telecommunication, automatically functioning, and which is protected from being spied out. Duplicates of the secret codes G of all the participants are stored in a data bank of the module, together with their respective token K, and made available after the input of a specific K value. A trustworthy authority, for example a notary, checks whether the K value appertains to a specific owner, before the corresponding pair of values K⇄G is entered into the data bank. Once entered, the values K⇄G remain locked in the module forever.

After the input of the tripartite electronic signature I, the signature proof U* is recalculated from S in the module, with G belonging to K and the one-way algorithm, whereby precautions are taken that U* cannot be perceived from outside the module. Only the result of the comparison between the original U as entered in the module and the recalculated U* is reaching the outside.

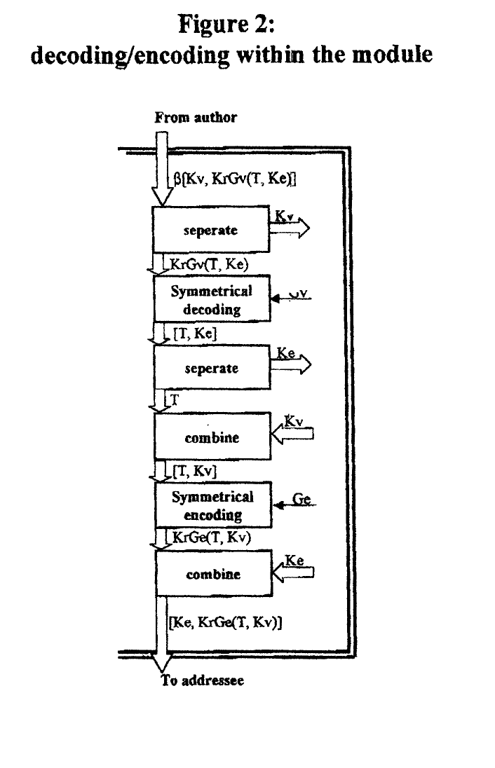

The autonomous module with its data bank for the value pairs K++G supervised by the trustworthy authority, is suited to implement an aggression safe symmetric cipher. Two participants may communicate as follows via the module: The author V of a text T encodes the latter and the token Ke of the addressee E with the symmetric cipher and his/her secret code Gv, and sends the resulting cipher value KrGv(T, Ke) with his/her token Kv to the module, together with a program run command β. There, Gv will be released by the use of Kv, and the entering cipher value KrGv(T, Ke) will be decoded with the symmetric cipher. By this, the text T and Ke are made available. Input of Ke into the data bank will release the secret code Ge of the addressee. The text T and the token Kv are encoded with Ge and the symmetric cipher. The resulting cipher value KrGe(T, Kv) is marked with Ke and transmitted from the module to the addressee who decodes the cipher value with Ge and the symmetric cipher. This decoding-encoding method inside the module is shown in FIG. 2. Because the sender encodes the addressee's token Ke, according to the invention, it is impossible that an aggressor intercepts the communication before it reaches the module, with the intention to replace Ke by his/her own token and to receive the communication via the module.

The value pairs K⇄G can be entered in the data bank of the module in different manners, according to claim 6. As a first alternative, the trustworthy instance enters the token K in the module, whereupon a secret code G will be generated in the module and passed out to the future participant in a safe way, for instance in two chip cards each of which contains half of the digits, and which are sent to the participant separately in closed envelopes. In the module, the value pair K⇄G is set up from the token K and the secret code G and entered in the data bank. This alternative does not impose upon the future participant the task to personally join the trustworthy instance, because he/she has the possibility to identify himself/herself at an officially admitted office in his/her neighborhood which will pass on his/her token and particulars to the instance, for example as an electronic message signed by a tripartite electronic signature I.

As a second alternative, the trustworthy authority enters the token K in the system, and the future participant introduces his/her chip card or diskette with the encoded secret code G. After authentication of the participant, the secret code G will be decoded in the system and released to it, and K and G will be transferred to the module.

According to a third alternative, the future participant encodes the secret code G with an asymmetric cipher, before he/she transmits it in this form and together with his/her token K to the trustworthy instance for input into the module. In the module, G will be correspondingly decoded before it enters the data bank.

For all of these three alternatives, the data to be entered in the module can be encoded by the trustworthy authority with a symmetric cipher, before they reach the module, in order to be correspondingly decoded in the module, before they enter the data bank. In this way, it is made sure that only the authority will be in a position to enter new value pairs K⇄G in the data bank. As a result, all of the three alternatives guarantee that no secret code G with a forged token K will get into the module, and furthermore that the authority will get no knowledge of the entered G-values.

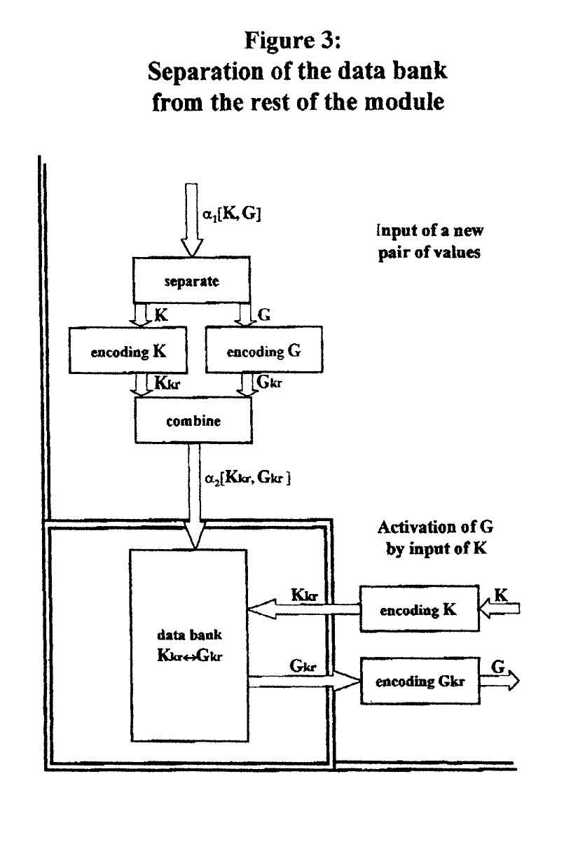

If the values K and G are entered and stored in the data bank in an encoded form, and used in such a way, access to the data bank for the purpose of maintenance or of producing safety copies is facilitated. Even in the very exceptional case that an aggressor would get knowledge of the encoded G, respectively, K values, which are stored in the data bank, he/she could not make anything of them because he/she would be unable to decode them. It lies in the framework of the invention to spatially separate a data bank designed according to the invention from the rest of the module with its algorithms and program runs. FIG. 3 shows how a new value pair [K, G], complemented by a program run command α₁, reaches the separate data bank in an encoded manner, and how it will be stored there in the form of the value pair Kkr⇄Gkr. FIG. 3 also shows how the relevant G value is released after calling up a K value in the rest of the module, by communication with the encoded data bank. Certain algorithms are needed for the operation of the data bank, without which the method according to the invention cannot be implemented. It goes without saying that similar or even different one-way and cipher algorithms with a secret code as a parameter can be used for the implementation of the method and its embodiments.

If a sequence of characters according to claim 7 represent a text T, the characteristic number Bt represents the text seal S(T), assuming that the digits cₙ of C are published. Supposing that the digits cₙ of C remain secret, C represents the secret code G, and Bt the signature proof U(S). In both cases it will be advantageous to employ only a few bₙ from the total quantity of all the bₙ, for instance the first fifteen, for the composition of Bt. S(T) may be used as the token K, if the text consists of the standardized particulars of a participant. In case the number C has many digits, and many or all bₙ are employed for the composition of Bt, a very large number Bt can be generated from any small sequence of characters with the one-way algorithm, and Bt can be used as the individual token G. The one-way algorithm guarantees that Bt cannot be obtained from T by trial, and that no two texts T, which result in the same value Bt, exist.

With a symmetric cipher, it is not necessary to go back to the Bit level as it is for the CAST-IDEA, and Triple-DES-algorithms. Because G needs at least as many digits g as necessary to attribute one g to each character L of the text, it is advantageous to use G values with many, for instance 1000 digits, for the processing of relatively long texts, of which only part is employed, if so required.

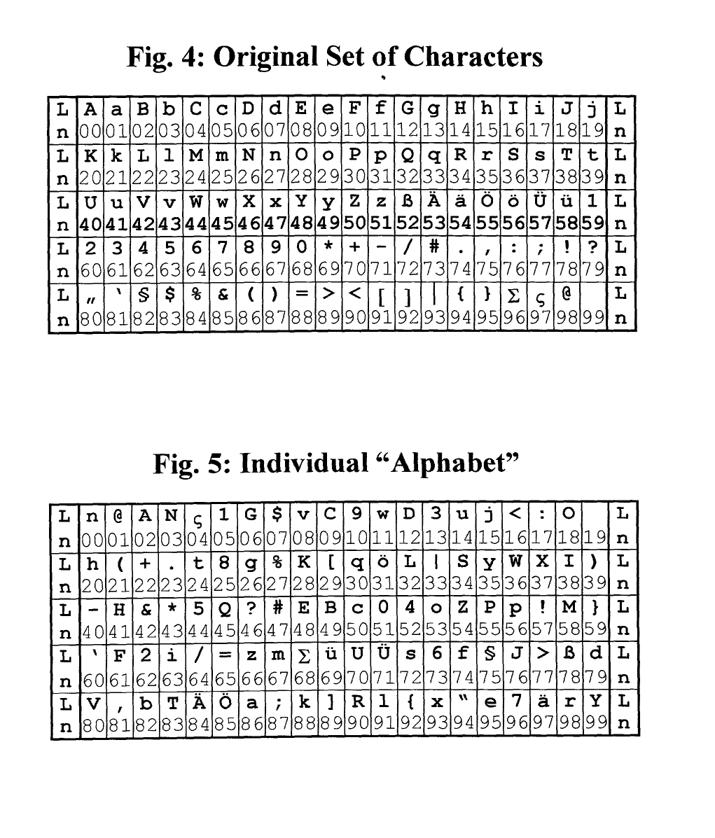

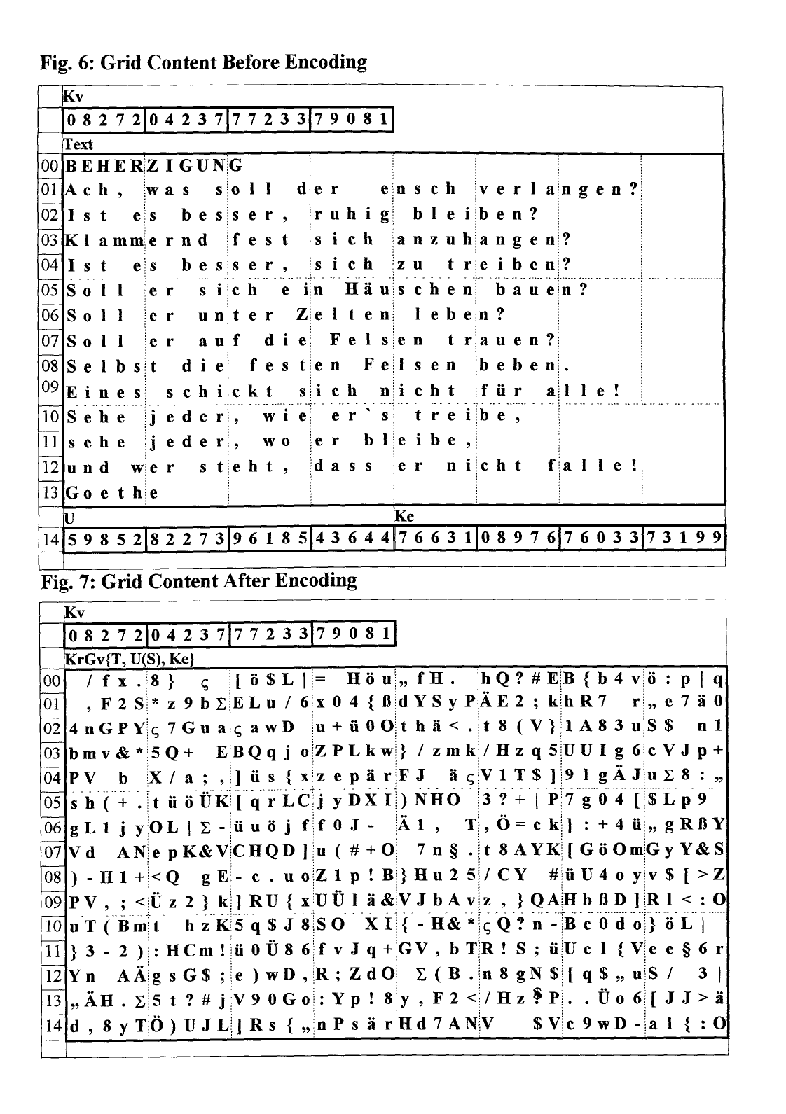

FIG. 5 shows a typical individual alphabet, as calculated during phase a) of the symmetric cipher, from the characters L of the set of characters of FIG. 4, with the first hundred digits of the 1000-digit secret code G=09480 51849 . . . . 15424 64281. FIG. 7 is the result of encoding the text of FIG. 6, including the values of U(S) and Ke which are noted in it. The total content of FIG. 7, i.e. the expression [Kv, KrGv{T, U(S), Ke}] is sent to the module with the program run command β according to FIG. 2, is transformed there, and then transmitted to the addressee in the form of the expression [Ke, KrGe{T, U(S), Kv)}]. For simplification, in FIG. 6 only the signature proof U is noted beneath the text, instead of the tripartite electronic signature I, whereas the token Kv is noted above the text.

There is a possibility of storing the secret code as a cipher value, safety measure, which is indispensable for the method of the invention, and of reconstructing it. This arrangement is advantageous because no PIN is needed.

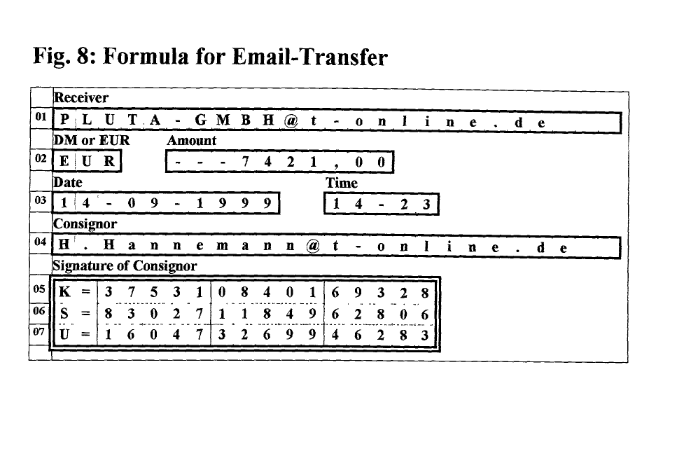

The tripartite electronic signature I as an equivalent of a hand written signature which is permanently placed on paper, can be used for example for a simplified and accelerated transfer of money by e-mails (FIG. 8). The credit institution opens an account for each client under his/her e-mail address. A transfer is executed as follows: The client fills in lines 01 to 04 of the form. The software calculates from these characters first the seal S, and then from S the signature proof U, after the client has introduced his/her chip card or diskette. Both numbers are entered in lines 06 and 07 of the form, and together with the client's token K of line 05 generate his/her tripartite electronic signature I. The form thus completed is mailed to the credit institution. If the client's account is covered, and after the credit institution has verified the client's tripartite electronic signature I by contact with the autonomous module, the amount entered in the form is booked on the receiver's account.

The credit institution can inform the receiver that he/she may dispose of his/her credit entry immediately, by means of a corresponding e-mail form signed with its tripartite electronic signature I. In case the receiver has not yet opened an e-mail account at the credit institution, the latter offers him/her the possibility to do so, and puts the amount to his/her credit, if he/she accepts the offer. If not, the credit institution will transfer the amount to him/her in a conventional way.

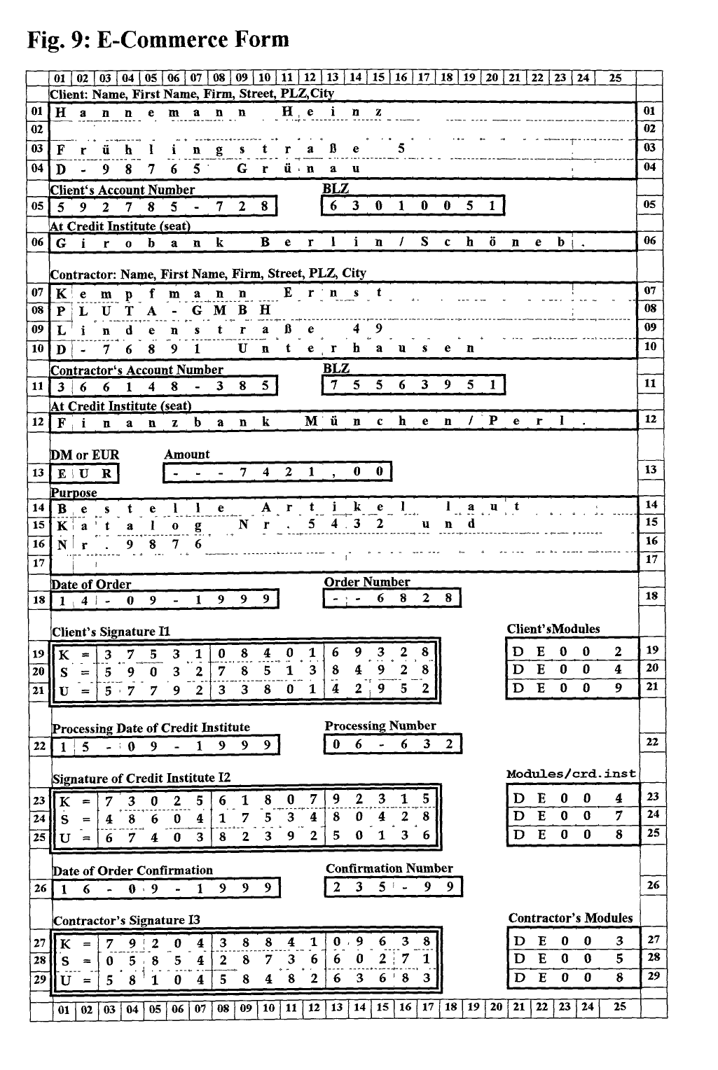

Another application of the tripartite electronic signature I is in the field of e-commerce (FIG. 9). On the screen of his/her PC, the client fills in lines 01 to 18 of the form, the software calculates from these characters first the seal S and next, exclusively by means which are under the sole control of the client, from S the signature proof U. Both numbers are entered in lines 20 and 21 of the form and make up, together with the client's token K in line 19, his/her tripartite electronic signature I1. The form thus completed is sent to the credit institution.

If the client's account is covered, and after the credit institution has verified I1 by contact with one of the identical autonomous modules of the client (DE002, DE004 or DE009), the amount inscribed on the form is booked onto a clearing account, and a confirmation mark of the credit institution is entered in line 22 of the form. The software calculates first the corresponding seal S from the characters of lines 01 to 22, and next, exclusively with means under the sole control of the credit institution, from S the signature proof U. Both numbers are entered in lines 24 and 25 of the form and result, together with the token K of the credit institution in line 23, in its tripartite electronic signature I2. The form thus completed is sent to the contractor.

The contractor verifies I2 by contact with one of the identical autonomous modules of the credit institution (DE004, DE007, or DE008), executes the order, and enters his/her confirmation mark in line 26. The software calculates first the corresponding seal S from the characters of lines 01 to 26, and next, exclusively with means under the sole control of the contractor, from S the signature proof U. Both numbers are entered in lines 28 and 29 of the form and result, together with the token K of the contractor in line 27, in his/her tripartite electronic signature I3. The form thus completed is sent to the client who verifies for safety I3 by contact with one of the identical autonomous modules of the contractor (DE003, DE005, or DE008). After having received the merchandise in conformity with his/her order, the client empowers his/her credit institution to transfer the relevant amount from the clearing account to the contractor's account.

The method according to the invention with the tripartite electronic signature I, replacing or supplementing a hand written signature according to the invention, benefits from the fact that on-line and off-line operation are possible, for instance via the telephone network or in e-mail operation. In the case of decoding-encoding inside the module, a mailbox is placed before the module, in which all incoming e-mails are collected and successively treated in the module. Thereafter, the e-mails are provided with the e-mail address belonging to the relevant token and passed on to the addressees. These addresses may be registered in an external data bank from where they are picked up after the program run in the module.

Further benefits of the method according to the invention as compared with the conventional electronic signature are: the simple formalities for its use, the suppression of a complicated infrastructure for key certification, the dispensation with calculations at the Bit level, the possibility to easily implement secret and falsification-proof Internet voting systems.

What is claimed is:

1. A method for the verification of the integrity and authorship of a text comprising the following steps:
every participant is equipped with at least:
a token K characterizing the participant;
an individual secret code G;
and a one-way algorithm depending on the secret code G;
a module exists which cannot be spied out and which is accessible by telecommunication, containing at least:
a data bank, storing for each participant a value pair consisting of his/her token K and his/her individual secret code G, pair which can only be entered in the data bank after the participant has proved his/her identity and token K towards a trustworthy instance, and from which data bank the relevant secret code G will be released within the module after entering a specific token K;
and the one-way algorithm depending on the secret code G;
A participant calculates from the text characters and their disposition with his/her secret code G and his/her one-way algorithm a characteristic number, identifying the text and himself/herself, and marks the text by a note which contains at least the characteristic number and his/her token K.
For the purpose of verification:
the text with the note is transmitted to the module;
the secret code G is released within the module by the token K;
the characteristic number is recalculated within the module from the text with the secret code G and the one-way algorithm and, not perceivably from the outside, compared with the original of the characteristic number as entered in the module;
the result of the comparison is communicated to the verifying person.

2. A method according to claim 1, wherein:
a participant first calculates, with a generally accessible one-way algorithm, from the characters of the text and their disposition, a characteristic number S identifying the text, and next from S with his/her secret code G and his/her one-way algorithm, a characteristic number U identifying himself/herself, finally marks the text by a note which contains at least the characteristic number S, the characteristic number U, and his/her token K;
For the purpose of verification:
the verifying person first recalculates with the public one-way algorithm, from the characters of the text and their disposition, the characteristic number S identifying the text, and compares S with the corresponding value of the note;
the note is sent to the module;
the secret code G is released within the module by the ID K;
the characteristic number U is recalculated within the module from the characteristic number S, with the secret code G and the one-way algorithm and, not perceivably from the outside, compared with the original of the characteristic number U as entered in the module; and
the result of the comparison is communicated to the verifying person.

3. A method according to claim 1, wherein the secret codes G are entered in the data bank as cipher values and are stored there in that form, in order to be released after input of a specific token K into the data bank as a cipher value, and to be decoded within the module with a cipher algorithm corresponding to that one used for transforming the plain G into the cipher G.

4. Method according to claim 3, characterized in that also the tokens K are entered in the data bank as cipher values and there are stored in that form, and that after calling up a specific token K in the module in order to activate the corresponding secret code G, this token K first is encoded with the cipher used for encoding the tokens K when they are initially entered into the data bank, and then is entered in the data bank in cipher form.

5. A method according to claim 1, wherein:
A participant in his/her capacity as an author V encodes with his secret code Gv and a symmetric cipher depending on Gv, his/her plain text and the token Ke of an addressee E, to a cipher text;
For the purpose of decoding:
the cipher text is transmitted with the token Kv of the author to the module;
within the module the secret code Gv is released by the token Kv;
within the module and not perceivably from the outside, the cipher text is decoded to the plain text and the token Ke, with the secret code Gv and the symmetric cipher equally placed within the module;
within the module, the secret code Ge is released by the token Ke;
within the module and not perceivably from the outside, the plain text and the token Kv are encoded to a cipher text, with the secret code Ge and the symmetric cipher;
this cipher text is transmitted with the token Ke to the addressee;
The addressee decodes the cipher text to the plain text and the token Kv, with his/her secret code Ge and his/her symmetric cipher.

6. A method according to one or more of the claims 1, wherein the value pair made up of the token K and the secret code G of a new participant, is entered via the module in the data bank alternatively as follows:
a) After the trustworthy authority has entered the token K in the module, a secret code G is generated there automatically, which is entered in the data bank together with the token K, and attributed to the participant on a safe way.
b) The trustworthy authority first enters the token K in the system, and separately, however within a common program step, the new participant enters his/her secret code G. Next, the value pair is transferred into the data bank.
c) The new participant encodes his/her secret code G with an asymmetric cipher, before he/she transmits G in this form with his/her token K, to the trustworthy authority for entering in the system; within the module, the secret code G is decoded with a corresponding asymmetric cipher available in the module.
d) The data to be entered in the module are encoded with a symmetric cipher, before they reach the module; and within the module, they are decoded with a corresponding symmetric cipher there available within the module.

7. A method according to claim 1, wherein:
the text consists of a sequence of characters L;
the one-way algorithm depends on a number C with the digits cₙ;
a number B with the digits bₙ is calculated from the one-way transformation of the text, the quantity of all bₙ corresponding either to the number of all L or of all cₙ;
a partial quantity of all digits bₙ of the number B is used as the characteristic number Bₜ, and
the calculation of the characteristic number is performed (goes exactly or analogously) as follows:
a) The characters L are replaced by their ordinal number Z in the applied set of characters, or by another characteristic number Z.
b) The numbers Z are consecutively numbered from n=0 to n=fin.
c) From the thus generated sequence of numbers Zₙ, the digits bₙ are calculated by a single or repeated iteration from n=0 to n=fin, and from n=fin to n=0, applying the formulas
aₙ=Mod[Int{(Zₙ+cₙ+rₙ)ˆ c2;10ˆ c3}]
r0=c1
rₙ+1=aₙ
bₙ=Rest(a_{n;}10)
in which c1, c2, and c3 are constants.

8. A method according to claim 5, wherein:
The text consists of a sequence of characters L;
The secret code G consists of at least as many digits g as needed to attribute one digit g to each L;
The symmetric cipher depends on the secret code G;
The encoding/decoding of plain/cipher texts which consist of this sequence of characters runs exactly or analogously as follows:
a) Generation of an individual “alphabet”:
The characters L of the given set of characters (including a blank character) are consecutively numbered from p1=0 to p1=fin1, resulting in ordinal numbers p1=1, 2, 3 etc. with x digits. To each p1 is attributed the corresponding g value of the secret code G.
The g values thus attributed are cyclically shifted by one unit, two units, and three units, whereby new sequences of numbers are created with the digits g′, g″ and g′″.
From the numbers p1 and g, g′, g″ and g′″ which belong to one another, the sequence of composite numbers Zsort is formed:
Zsort=10ˆ (x+3)*g+10ˆ (x+2)*g′+10ˆ (x+1)*g″+10ˆ x*g′″+p1
The sequence of the numbers Zsort is ordered according to increasing size, and is consecutively numbered in this arrangement from p2=0 to p2=fin1. Ordinal numbers p2=1, 2, 3 etc. with x digits are thus created; from the adjusted p1 results the permutation P1 of these numbers, and from the characters L of the given set of characters an individual “alphabet”.
If the numbers p1 are again ordered according to increasing size, the permutation P2 of these numbers is obtained from the numbers p2.
b) Substitution:
All the characters L of the original text (including the blank characters) are consecutively numbered from p1*=0 to p1*=fin2. Ordinal numbers p1*=1, 2, 3 etc. with x digits are thus created. To each p1* is attributed the corresponding g value of the secret code G.
According to the method described under a), the two interdependent permutations P1* (p2* adjusted) and P2* (p1* adjusted) are created with the g values.
To each character L of the original text, its ordinal number p2 in the individual “alphabet” and the numbers p2* of the P2* permutation, are attributed.
Modular addition of the values p2 and p2* results in the numbers p3=Mod(p2+p2*; fin1) which are defined as ordinal numbers of the substituted characters Ls in the individual “alphabet”.
The numbers p3 are replaced by the characters Ls which are attributed to them in the individual “alphabet”.
c) Transposition:
The substituted characters Ls are transposed by application of the P1 * permutation (rearrangement of the numbers p2* in ascending sequence), resulting in the cipher text with the characters Lk.
d) Decoding:
The characters Lk are re-transposed by application of the P2* permutation (rearrangement of the numbers p1* in ascending sequence), resulting in the sequence of the characters Ls.
Each Ls is replaced by its ordinal number in the individual “alphabet”.
Modular subtraction p2=p3−p2* results in the ordinal number of the original character L.
The number p2 is replaced by L. The result is the original plain text.

9. A method according to claim 1, wherein the secret code G with its digits g, is stored on a data carrier as a cipher value, and is reconstituted before the use, as follows:
the sequence of the digits g is subdivided into continuous groups;
each group of digits is attributed to one of the constituents B of a number of person-specific associations A⇄B;
the constituents A of the associations are put in order, and the constituents B, together with their group of digits g, are mixed and stored on the data carrier;
for reconstitution, the data carrier is laid into a reading device, and the constituents A appear on a display one after another, and the constituents B simultaneously;
the owner of the secret code G attributes the correct B to each appearing A;
from the sequence of digit g groups thus adjusted, the secret code G is reconstituted;
after each reconstitution, the associations A⇄B are mixed without their groups of digits g, whereas the latter remain in their sequence;
each group is attributed to one of the constituents B of the person-specific associations A⇄B in their new arrangement, and so on.
